(19) United States
(12) Patent Application Publication
(10) Pub. No.: US 2007/0133431 A1
(43) Pub. Date: Jun. 14, 2007

(54) Media access control method in wireless local area network

(76) Inventors: Ki Jong Koo, Daejeon-city (KR); Dae Ho Kim, Daejeon-city (KR); Do Young Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/634,675

(22) Filed: Dec. 6, 2006

(30) Foreign Application Priority Data
Dec. 9, 2005 (KR) 10-2005-0121002
Sep. 29, 2006 (KR) 10-2006-0096598

(51) Int. Cl. H04J 1/16

(52) U.S. Cl. 370/252; 370/395.21

(57) ABSTRACT

A media access control method in a wireless local area network is provided. The media access control method includes assigning a QoS (quality of service) slot to each of mobile terminals which request a transmission of a voice frame by exchanging frames for ensuring QoS between the mobile terminals and an AP (access point) which is connected to the mobile terminals through a wireless link, dividing a unit time interval of the wireless link for the transmission of the voice frame into time intervals each of which corresponds to the least common multiple of generation periods of the voice frames of the mobile terminals, dividing the divided time interval corresponding to the least common multiple (QoS frame transmission intervals), and assigning each QoS slot to each of the QTX-INTs and transmitting the voice frame from each of the mobile terminals through the QoS slot.

### CROSS-REFERENCE TO RELATED PATENT APPLICATION

This application claims the benefit of Korean Patent Application No. 10-2005-0121002, filed on Dec. 9, 2005 and Korean Patent Application No. 10-2006-0096598, filed on Sep. 29, 2006, in the Korean Intellectual Property Office, the disclosures of which are incorporated herein in their entirety by reference.

### BACKGROUND OF THE INVENTION

1. Field of the Invention

The present invention relates to a media access control method in a wireless local area network (LAN), and more particularly, to a media access control method capable of improving quality of service (QoS) of a voice over internet protocol (VoIP) system in a wireless network.

2. Description of Related Art

Generally, wireless local area networks (LANs) operate within the range of 100 meters at a speed of 10 to 100 Mbps. A wireless LAN composed of a single cell may be efficiently used for a single story office or store. Using a wireless network interface card (NIC), A terminal of the wireless LAN is connected to other terminals and an access point (AP) on the network through a radio frequency (RF) link.

The AP enables the terminal of the wireless LAN to connect to a wired network through a backbone network. About 25 terminals can be connected to a single cell of the wireless LAN. Multiple cells may be configured by using a plurality of APs which are connected to the wired network, and the multiple cells may be used to build a wireless LAN environment for a whole building.

IEEE developed a standard which defines a protocol for transmission of data frames between a terminal of a wireless LAN and an AP. As a result, a standard for a wireless LAN medium access and physical layer (IEEE Std. 802.11, IEEE standard for Wireless LAN Medium Access (MAC) and Physical Layer (PHY), 1999) was established.

The IEEE 802.11 wireless LAN standard defines a mobile terminal and a fixed AP which are two important elements of the wireless LAN. A single cell using the IEEE 802.11 wireless LAN standard is defined as a basic service set (BSS), and a multiple cell is defined as an extended service set (ESS).

In the IEEE 802.11 wireless LAN standard, each terminal and AP configures a media access control (MAC) layer which has a function for exchanging MAC frames. The MAC frame is used as a medium which transmits control information, management information, and data between a terminal of the wireless LAN and an AP.

In the IEEE 802.11 wireless LAN standard, two methods of access of a wireless medium to the MAC layer are defined. One is a distributed coordination function (DCF), and the other is a point coordination function (PCF).

<DCF (Distributed Coordination Function)>

In the DCF, every one of a plurality of stations can participate in the arbitration for frame transmission. The basic access method of a MAC of the IEEE 802.11 standard is a carrier sense multiple access with collision avoidance (CSMA/CA). In the CSMA method, a station which wants to transmit data on the wireless LAN(WLAN) wireless medium detects the wireless medium for checking whether there is data transmission from another station. When the wireless medium is vacant, the data transmission from the station can be made. Otherwise, the station delays the transmission until the data transmission from another terminal is completed.

When the data transmission is available right after the data transmission on the wireless medium is completed, a plurality of stations may try to transmit data. As a result, a probability of data collision is increased. To prevent the increase in the probability of the data collision, when a predetermined stand-by period elapses after the data transmission is completed binary random back-off used for providing the stations with a transmission timing is performed to determine a contention window (CW) period for each station, and a priority of data transmission is given to a station having the shortest CW period. The procedure described above is a function of collision avoidance (CA).

<PCF (Point Coordination Function)>

In a PCF, a point coordinator (PC) controls data transmission of a wireless LAN terminal. The PC serves as a polling master and polls all the terminals which can be polled to select a terminal which can transmit data. The PC may reside in an AP, and a terminal used in a PCF may or may not have a polling function.

When a terminal which has the polling function, is polled by the PC, only one MAC protocol data unit (MPDU) can be transmitted. When additional transmission is required, the terminal should stand by until being polled again. When data transmission from a terminal is completed abnormally, the terminal may not perform re-transmission of data until being polled by the PC. Therefore, the PCF provides a contention free mechanism so as to provide the terminal with a timing for transmitting the data normally.

<EDCF (Enhanced Distributed Coordination Function)>

An enhanced DCF (EDCF) defined by the standard IEEE 802.11e is to improve QoS by adjusting the CW period. Arbitration among many stations is performed for accessing network for a CW period, and the MAC protocol requests the stations to stand by for the CW period which is selected by the binary random back-off. Owing to the CW period, the possibility of collision among the stations decreases.

The EDCF uses the CW period for assigning a high priority to a specific station. The high priority can be assigned by providing a short CW period to a specific station. As a result, in most cases, a terminal having a high priority can transmit data prior to a terminal having a low priority.

<PTDM (Pseudo-Time Division Multiplexing)>

In a PTDM method, a wireless link is divided according to a generation period of a voice frame, and a quality-of-service slot (QSLOT) is provided to each wireless LAN terminal for each divided period, so that the voice frame can be transmitted. The QSLOT includes a voice frame, an acknowledgement (ACK), and an inter-frame-space (IFS). In the QSLOT period, only a corresponding terminal can transmit a frame without contention, so it is possible to transmit a voice frame at a predetermined time, so that the QoS in a wireless transmission segment described can be improved.

However, the methods of wireless media access described above have following problems in terms of guarantying QoS.

In the DCF method, a frame delay occurs, since the binary random back-off is performed before frame transmission. In the EDCF method, a priority can be assigned to a voice frame by providing a voice frame with a CW period shorter than that of a data frame. However a frame delay occurs since the back-off is also performed in this method.

In the PCF method, the frame delay occurs, since a wireless LAN terminal can transmit a frame only by polling in a contention free period. The PTDM method is adequate for a BSS configured by terminals having a same generation period of a voice frame. However, in a BSS, configured by terminals having a different generation period of a voice frame, transmission delay of a voice frame from a terminal and a jitter occur, since there is no function for extracting a common generation period from different voice frames.

### SUMMARY OF THE INVENTION

The present invention provides a media access control method in a wireless local area network (LAN).

According to an aspect of the present invention, there is provided a media access control method in a wireless local area network, the method comprising: (a) assigning a QoS (quality of service) slot to each of mobile terminals which request a transmission of a voice frame by exchanging frames for ensuring QoS between the mobile terminals and an AP (access point) which is connected to the mobile terminals through a wireless link; (b) dividing a unit time interval of the wireless link for the transmission of the voice frame into time intervals each of which corresponds to the least common multiple of generation periods of the voice frames of the mobile terminals; (c) dividing the divided time interval corresponding to the least common multiple into QTX-INTs (QoS frame transmission intervals); and (d) assigning the QoS slot to each of the QTX-INTs and transmitting the voice frame from each of the mobile terminals through the QoS slot.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a structure of a wireless local area network system for ensuring quality of service (QoS) for a voice frame in a wireless link according to an embodiment of the present invention;

FIG. 2A is a diagram illustrating procedures for exchanging frames for guarantying the QoS in FIG. 1 according to an embodiment of the present invention;

FIG. 2B is a diagram illustrating the structure of frames used for the procedures for exchanging the QoS frames in FIG. 2A;

FIGS. 3A and 3B are timing charts illustrating methods of dividing a unit time interval of a wireless link for a transmission of a voice frame according to a generation period of a voice frame according to an embodiment of the present invention;

FIG. 4 is a timing chart illustrating a method of dividing a wireless link for transmitting a voice frame based on an EPTDM method according to an embodiment of the present invention; and

FIG. 5 is timing chart illustrating a method of assigning a wireless link when an AP transmits a voice frame from a mobile terminal to another mobile terminal which belongs to the same BSS according to an embodiment of the present invention.

### DETAILED DESCRIPTION OF THE INVENTION

The object and technical problem of the present invention is to provide a media access control method. According to the method, a common generation period of voice frames of different terminals which configure a same basic service set (BSS) and have different generation periods of a voice frame from each other is extracted in the transmitting of a voice frame through a wireless link. So, this method is capable of decreasing a frame transmission delay and jitter without performing a back-off or polling to improve a quality of service (QoS) of a voice over internet protocol (VoIP) system in a wireless local area network (LAN).

In order to achieve the object and technical problem, the present invention discloses an enhanced pseudo-time division multiplexing (EPTDM) method. The key function of the EPTDM of the present invention is to divide the wireless link into a common generation period of a voice frame and to provide a dedicated time slot through which only a voice frame can be transmitted under an environment that terminals having different generation periods of voice frames in the same BSS. As a result, a transmission frame delay and a jitter can be decreased to improve QoS of the wireless transmission segment.

Hereinafter, the present invention will be described in detail by explaining exemplary embodiments of the invention with reference to the attached drawings. Like reference numerals in the drawings denote like elements. Elements in another figure may be referenced in describing a figure.

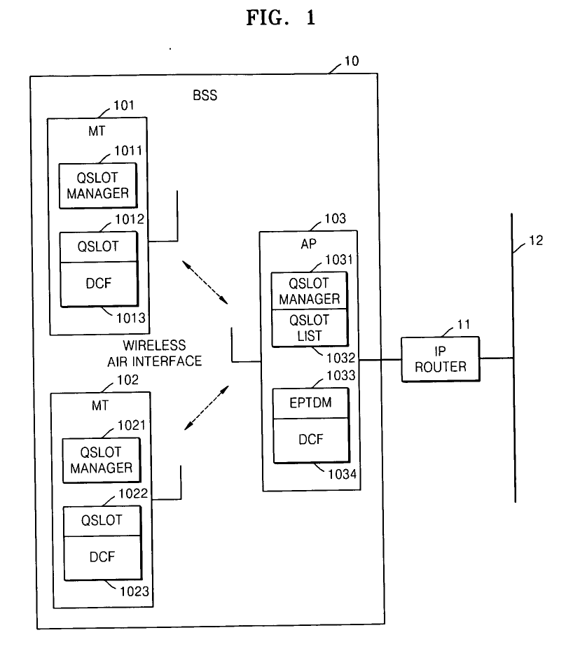

FIG. 1 is a block diagram illustrating a structure of a wireless local area network system for guarantying QoS for a voice frame in a wireless link segment according to an embodiment of the present invention.

Mobile terminals (MTs) 101 and 102 together with an access point (AP) 103 which is connected to the MTs 101 and 102 through a wireless air interface form a BSS 10 to be connected to a wireless LAN. The wireless LAN is connected to an Internet backbone (IB) network 12 through an internet protocol (IP) router 11. Information is transmitted through an up-stream path formed starting from the MTs 101 and 102, passing through the AP 103, and reaching the IB network 12 and a down-stream path which is a path formed starting from the IB network 12, passing through the AP 103, and reaching the MTs 101 and 102.

The MTs 101 and 102 and the AP 103 use distributed coordination functions (DCF) 1013, 1023, and 1034 which are based on the standard IEEE 802.11-1999 and EPTDMs 1012, 1022, and 1033 according to an embodiment of the present invention. The MTs 101 and 102 within the same BSS 10 include voice codecs having the same generation period of voice frames.

The MTs 101 and 102 manage generation period information of a voice frame and quality of service slot (QSLOT) information using QSLOT managers 1011 and 1021. The AP 103 manages QSLOTs of MTs which are connected to the AP 103 using a QSLOT manager 1031 and a QSLOT list 1032.

The MTs 101 and 102 exchange frames including QoS information with the AP 103 before transmitting a voice frame and then receive assignments of QSLOTs through which the voice frame can be transmitted. The procedures for exchanging frames and transmitting a frame using a QSLOT will be described below and later in detail.

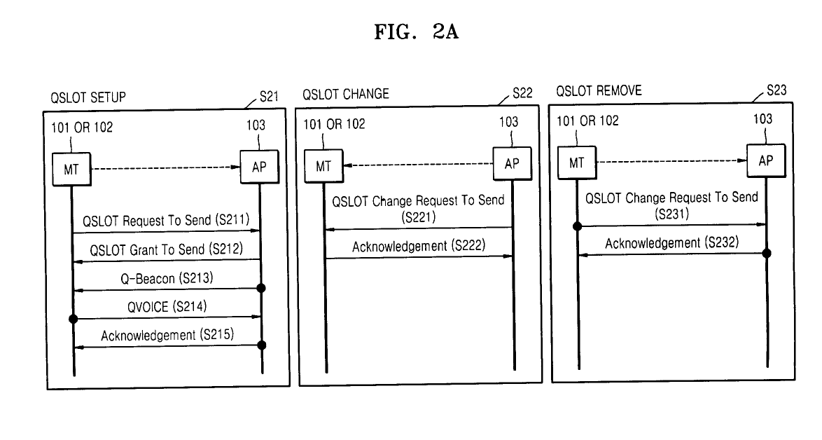

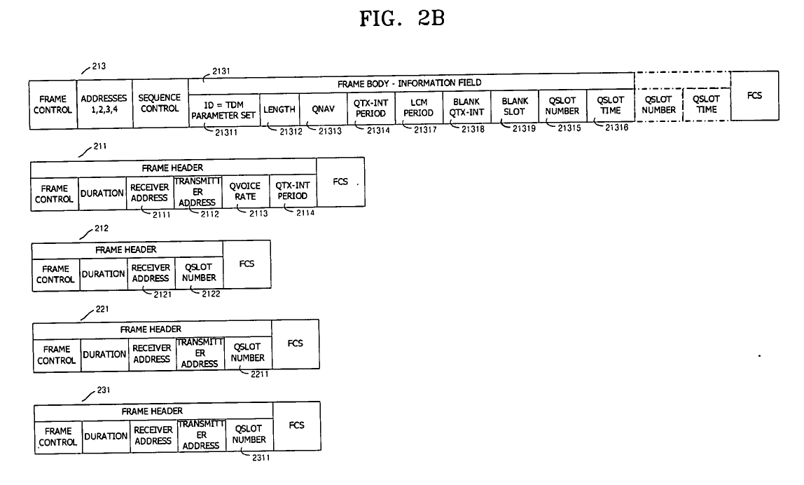

FIG. 2A is a diagram illustrating the procedures for exchanging frames in order to manage a QSLOT according to an embodiment of the present invention.

The procedures for exchanging QoS frames to manage a QSLOT include a QSLOT setup operation S21, a QSLOT change operation S22, and a QSLOT remove operation S23.

The procedure for exchanging QoS frames for the QSLOT setup operation S21 is as follows.

The mobile terminal 101 or 102 sends a QSLOT setup requesting frame “QSLOT REQUEST TO SEND” (QRTS) to the AP 103 when there is a voice frame to be sent (S211). The AP 103 which has received the QRTS frame assigns a QSLOT number (QN) to the mobile terminal 101 or 102 according to the QSLOT list 1032 and sends a QSLOT grant frame “QSLOT GRANT TO SEND” (QGTS) including the QN to the MT 101 or 102 (S212). The QN will be described later in detail.

The mobile terminal 101 or 102 to which the QN is assigned extracts the QSLOT information from a QoS beacon (Q-BEACON) frame 213 (see FIG. 2b) and sends a voice frame using a corresponding QSLOT to the AP 103 (S214) after the Q-BEACON frame is received from the AP 103 (S213). The AP 103 which has received the voice (QVOICE) frame from the mobile terminal 101 or 102 sends an acknowledgement frame (ACK) (S215) to accomplish setting up the QSLOT (S21). The transmission of frames in the QSLOT will be described later in detail.

The procedure for changing a QSLOT (S22) is as follows.

When a change in the QN of the mobile terminal 101 or 102 is required to minimize the QSLOT list 1032, the AP 103 sends a frame for requesting to change the QSLOT “QSLOT CHANGE REQUEST TO SEND” (QCRTS) 221 (see FIG. 2b) (S221). The mobile terminal 101 or 102 which has received the QCRTS frame updates the QN according to the request to change the QSLOT and sends an acknowledgement frame (S222) to achieve a change in the QSLOT (S22).

The procedure for exchanging QoS frames to remove a QSLOT (S23) is as follows.

The mobile terminal 101 or 102 sends a frame for requesting to remove a QN from the QSLOT list 1032 “QSLOT REMOVE REQUEST TO SEND” (QRRTS) 231 (see FIG. 2b) to the AP 103 (S231), after finishing transmission of the voice frame. The AP 103 which has received the QRRTS frame removes the QN of the corresponding mobile terminal 101 or 102 from the QSLOT list 1032, and then sends an acknowledgement frame (S232) to complete the removal of the QN (S23).

FIG. 2B is a diagram illustrating the frame format used for the procedures for exchanging the QoS frames in FIG. 2A according to an embodiment of the present invention.

In a Q-BEACON frame 213, an information field (INF) 2131 is added to a beacon frame defined by the standard IEEE 802.11. The INF 2131 includes an identification (ID) 21311, a length 21312, a OSLOT network allocation vector (QNAV) 21313, a QoS frame transmission interval (QTX-INT) period 21314, a QSLOT number (QN) 21315, and a QSLOT time (QT) 21316.

The ID 21311 is assigned with a TDM parameter set, and the length 21312 denotes a length of the INF 2131 in units of bytes. The QNAV 21313 denotes a length of a contention free period (CFP), and the QTX-INT period 21314 denotes a generation period of a voice frame, and the QN 21315 is an identification number of a QSLOT which is assigned to the mobile terminal 101 or 102. The QN starts from one (1) and increases in increments of one (1) for each mobile terminal 101 or 102 which requests a QSLOT. The QSLOT time 21316 is a duration time of a QSLOT corresponding to the QN 21315. When multiple MTs request the AP 103 for a QSLOT, the number of QNs 21315 and QTs 21316 is the same as the number of the MTs which request the QSLOTs (Dotted lines in FIG. 2B denote other QNs and QTs.).

An LCM period 21317 is a generation period of a voice frame which is the least common multiple (LCM) of generation periods of voice frames of terminals in a same BSS. A blank QTX-INT 21318 denotes a QTX-INT including a QSLOT through which a voice frame is not transmitted in the LCM period, and a blank QSLOT 21319 denotes a QSLOT through which a voice frame is not transmitted in the blank QTX-INT.

The “QSLOT REQUEST TO SEND” (QRTS) frame 211 is used when the MTs 101 or 102 requests for setting-up a QSLOT. An address of the AP 103 to which the set-up request is sent is assigned in a receiver address 2111. An address of the mobile terminal 101 or 102 which requests the QSLOT is assigned in a transmitter address 2112. Information on a transmission speed at which the mobile terminal 101 or 102 sends a voice frame is assigned in a QVOICE rate (QR) 2113. The AP 103 calculates the QSLOT TIME (QT) 21316 of the INF 2131 described above using the information on the transmission speed assigned to the QR 2113. A generation period of a voice frame of a mobile terminal 101 or 102 is assigned in a QTX-INT period 2114.

The QSLOT GRANT TO SEND (QGTS) frame 212 is used when the AP 103 assigns the QN to the MT 101 or 102. A receiver address 2121 is an address of a MT 101 or 102 which sends the QRTS frame 211. A QSLOT number 2122 is an identification number of a QSLOT which can be used by the MT 101 or 102 which requests the QSLOT.

The QSLOT CHANGE REQUEST TO SEND (QCRTS) frame 221 is used when a QN of the MT 101 or 102 which is connected to the AP 103 is required to be changed. The AP 103 updates the QSLOT list (QL) 1032 to minimize the length of the QNAV 21313 of the INF 2131 described above, and as a way of updating the QL, a change in the QN of the MT 101 or 102 which is connected to the AP 103 may be requested. At this time, a QN 2211 to be changed is inserted into the QCRTS frame 221, and the QCRTS frame 221 is sent to the corresponding MT 101 or 102. The MT 101 or 102 which has received the QCRTS frame 221 updates the QN.

The QSLOT REMOVE REQUEST TO SEND (QRRTS) frame (231) is used when the MT 101 or 102 requests to remove the QN of the corresponding MT 101 or 102 from the QSLOT list (QL) 1032 of the AP 103, after the MT 101 or 102 completes the transmission of the voice frame. The QN 2311 is an identification number of the QSLOT which is currently used by the MT 101 or 102.

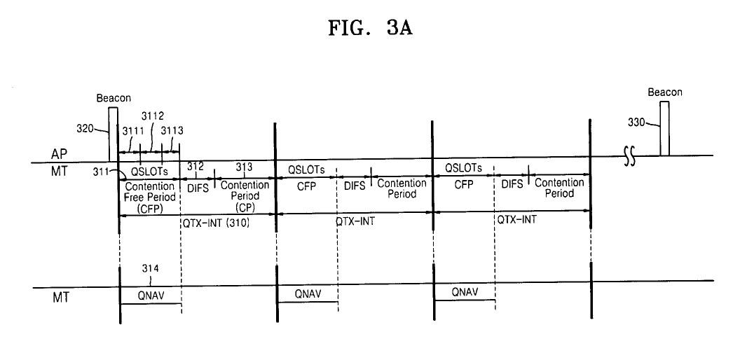

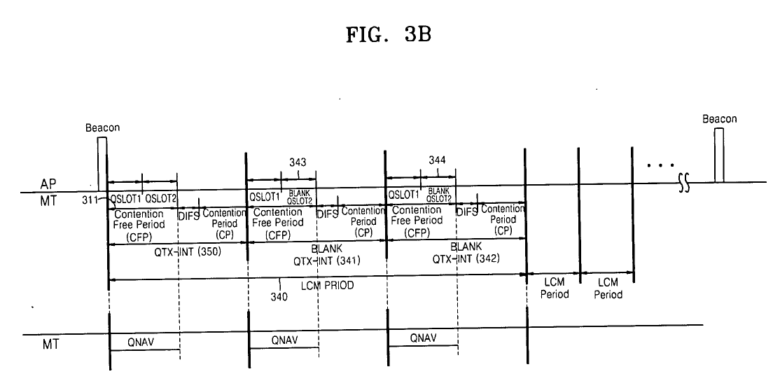

FIGS. 3A and 3B are timing charts illustrating methods of dividing a unit time interval of a wireless link for transmission of a voice frame according to a corresponding voice frame generation period according to an embodiment of the present invention.

From a macroscopic view, the unit time interval of the wireless link (hereinafter referred to as a “wireless link interval”) is divided based on the QTX-INT (310) in FIG. 3A and based on the LCM period 340 in FIG. 3B.

The QTX-INT 310 is a generation period of a voice frame which is the greatest common divisor of generation periods of voice frames which are different from each other within a BSS and the QTX-INT 310 separates a Q-BEACON 320 from another Q-BEACON 330 in FIG. 3A. As an example, when a terminal including a voice codec capable of processing 75 bytes every 10 ms and a terminal including a voice codec capable of processing 75 bytes every 30 ms exist in one BBS, the QTX-INT is set to 10 ms which is the greatest common divisor of generation periods of a voice frame of the two voice codecs.

The LCM period 340 is a generation period of a voice frame which is the least common multiple of generation periods of voice frames which are different from each other within a BSS. Blank QTX-INTs 341 and 342 denote a QTX-INT including blank QSLOTs 343 and 344 in the LCM period, and the blank QSLOTs 343 and 344 denote QSLOTs through which a voice frame is not transmitted in the blank QTX-INTs 341 and 342.

For example, the LCM period 340 is set to 30 ms which is the least common multiple of generation periods which are 10 ms and 30 ms of a voice frame of the two voice codecs. At this time, the voice codec having a generation period of a voice frame of 30 ms does not generate a voice frame in the second and third QTX-INTs 341 and 342 of an LCM period after generating a voice frame in the first of the LCM period QTX-INT 350. As described above, a QSLOT through which a voice frame is not actually transmitted by a MT although the QSLOT is assigned is called BLANK-QSLOTs 343 and 344 and a QTX-INT including a BLANK-QSLOT is called a blank QTX-INT 341 or 342.

In FIG. 3B, the second and third QTX-INTs 341 and 342 in a LCM period 340 become the blank QTX-INTs, and QSLOTs 343 and 344 in the blank QTX-INTs for the 30 ms voice codec become the BLANK-QSLOTs.

Every QTX-INT or blank QTX-INTs includes a contention free period (CFP) 311 and a contention period (CP) 313, and the CFP 311 includes at least one of the QSLOTs 3111, 3112, or 3113. The CP 313 begins after the CFP is over, standing-by for a distributed coordination function inter-frame space (DIFS) 312.

All the terminals except for terminals to which QSLOTs are assigned set the QNAV 314 for the CFP 311 to prohibit a transmission of a frame. But a terminal can transmit a frame when a transmission of a frame and a process of a confirmation response for the frame can be performed within the BLANK-QSLOT 343 or 344, although the transmission of a frame is prohibited to the terminal.

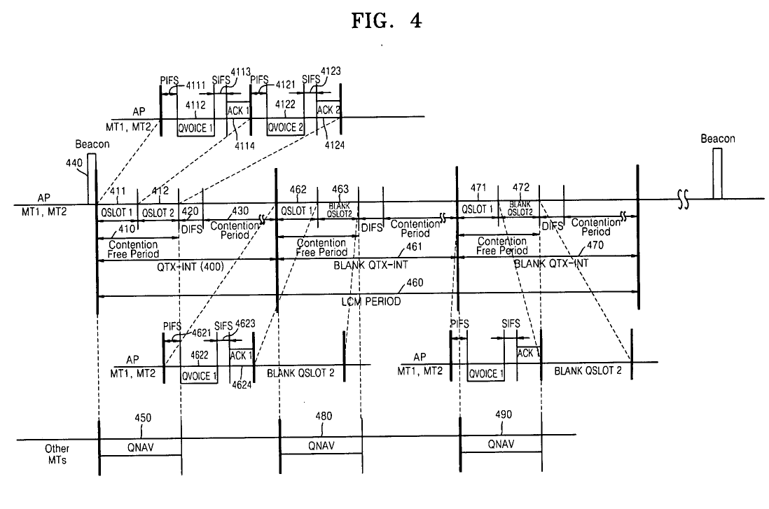

FIG. 4 is a timing chart illustrating a method of dividing a wireless link for transmitting a voice frame based on an EPTDM method according to an embodiment of the present invention.

The transmission of a voice frame based on the EPTDM method according to an embodiment of the present invention is performed in a period of an LCM period 460, using QSLOT intervals 411 and 412 in a QTX-INT 400. A method of transmitting a voice frame based on the EPTDM method will now be described with an example presented. Here it is assumed that generation periods of a voice frame of MTs 1 and 2 (MT1 and MT2) 101 and 102 are 10 ms and 30 ms, respectively.

The MT1 101 and MT2 102 which request to send voice frames, request for setting up QSLOTs by sending a QRTS1 frame and a QRTS2 frame to an AP 103, respectively, and request for QNs additionally. The AP 103 which has received the QRTS1 and QRTS2 frames assigns the QNs of MT1 101 and MT2 102 to QGTS1 and QGTS2 frames as QSLOT1 411 and QSLOT2 412, respectively. The MT1 101 or MT2 102 which has received an assignment for the QN stands by for a Q-BEACON frame 440 indicating a start of the LCM period 460 and QTX-INT 400.

An information field (INF) 2131 of a Q-BEACON frame 440 and 213, as illustrated in FIG. 2B, includes QSLOT numbers (QNs) 21315 and QSLOT times (QT) 21316, an LCM period 21317, a blank QTX-INT 21318, and blank QSLOT information 21319 of MT1 101 and MT2 102. In the example, since the number of MTs which have requested for setting up QSLOTs is two (MT1 101 and MT2 102), in the Q-BEACON frame 440 and 213, two QSLOT numbers (QNs) and two QSLOT times (QTs) are set. The QSLOT number starts with the number one (1), which is for the QSLOT which is generated right after the Q-BEACON, and increased in increments of one (1) for each additional QSLOT such as QSLOT1, QSLOT2, and QSLOT3.

When the Q-BEACON is received, all the MTs other than the MT1 101 and MT2 102 which have received QSLOTs extract the QNAVs 450 and set the lengths of the CFPs 410 to defer the transmission of a frame. The MT1 101 and MT2 102 prepare the transmission of a voice frame in the corresponding QSLOTs 411 and 412.

Since MT1 101 generates a voice frame every 10 ms, the transmission of a voice frame can be performed in QSLOTs corresponding to all the QTX-INTs 400, 461, and 470 within the LCM period 460. Since the QN of the MT1 101 is one (1), after the MT1 101 fully receives the Q-BEACON frame, the MT1 101 stands by for the PIFS (point coordination function inter-frame space) 4111 time. After the PIFS time 4111 elapses, when the wireless link is in an idle state, the MT1 sends a voice frame (QVOICE-1) 4112 to the AP 103. The AP 103 which has received the QVOICE-1 4112 sends an acknowledgement-1 frame (ACK-1) 4114 to the MT1 101 after a short inter-frame space (SIFS) 4113 time and completes the QSLOT-1 411.

Since the MT2 102 generates a voice frame every 30 ms, the transmission of a voice frame can be performed only in a QSLOT corresponding to a first QTX-INT 400 within the LCM period 460, and the transmission of a voice frame cannot be performed in the QSLOTs corresponding to the remaining blank QTX-INTs 461 and 470. The MT2 102 extracts a QSLOT TIME (QT) of a QSLOT-1 and stores the QT in a timer. When the QSLOT time elapses, and the wireless link is in an idle state, the MT2 102 stands by for a PIFS 4121 time. When the wireless link is in an idle state after the PIFS time elapses, the MT2 102 sends a QVOICE-2 frame 4122 to the AP 103. The AP 103 which has received the QVOICE-2 sends an acknowledgement-2 frame (ACK-2) 4124 to the MT2 102 after a SIFS 4123 time and completes the QSLOT-2 412.

When stand-by for the DIFS 420 time elapses after all the QSLOTs are completed, that is, after the CFP is over, and the contention period (CP) 430 begins, the AP 103 and the MT 101 or 102 within the same BBS can transmit a frame by arbitration using a distributed coordination function (DCF). Before the transmission of a frame, all the MTs and AP check a remaining time of the QTX-INT using the CP 430. When a time required for the procedure for exchanging frames is grater than the remaining time of the QTX-INT, all the MTs and AP delay the transmission of the frame to the next CP.

When, there is a blank QTX-INT 461 or 470 within the LCM period 460, the QNAVs 480 and 490 are set to MTs other than the MT1 101 and MT2 102, so that the privilege for transmission only in the blank QSLOTS 463 and 472 is given to the terminals of which transmission of a frame is prohibited by setting the QNAVs 480 and 490. Accordingly, when it is possible to send a frame and process a confirmation response for the frame within the BLANK-QSLOT, the MTs other than the MT1 101 and MT2 102 can transmit the frame.

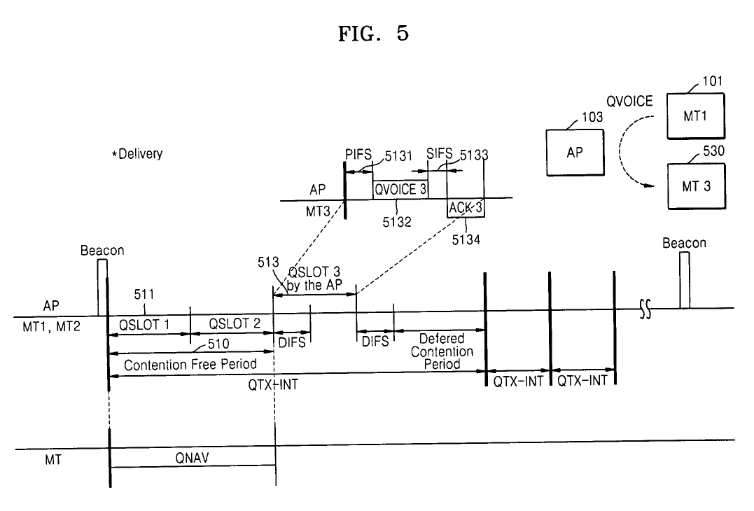

FIG. 5 is timing chart illustrating a method of assigning a wireless link when an AP transmits a voice frame from an MT1 to an MT3 which belong to the same BSS according to an embodiment of the present invention.

When a QVOICE frame is sent from an MT1 101 to an MT3 530 within the same BSS, the AP 103 stores the received QVOICE1 for the QSLOT1 interval 511, and when the CFP 510 is over, the AP 103 stands by for the PIFS time 5131, and thereafter transmits the QVOICE3 frame 5132 (the QVOICE1 frame transmitted from the MT1 to the MT3) to the MT3 530. When the SIFS time 5133 elapses after the MT3 530 receives QVOICE3, the MT3 530 sends an acknowledgement-3 frame (ACK-3) 5134 to the AP 103 to complete the procedure for exchanging the frames.

When the AP 103 does not perform the transmission of the QVOICE frame anymore, a deferred contention period (CP) begins after standing-by for the DIFS time. Since the MT1 101 and MT2 102 can transmit a frame during the DIFS after the CFP interval is over, the AP which stands by only for the PIFS acquires the right to use the wireless link.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, a common generation period of voice frames of different terminals which configure a same basic service set (BSS) and have different generation periods of a voice frame from each other is extracted in the transmitting of a voice frame through a wireless link. So, this invention is capable of decreasing a frame transmission delay and jitter without performing a back-off or polling to improve a quality of service (QoS) of a voice over internet protocol (VOIP) system in a wireless local area network (LAN).

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A media access control method in a wireless local area network, the method comprising:
(a) assigning a QoS (quality of service) slot to each of mobile terminals which request a transmission of a voice frame by exchanging frames for ensuring QoS between the mobile terminals and an AP (access point) which is connected to the mobile terminals through a wireless link;
(b) dividing a unit time interval of the wireless link for the transmission of the voice frame into time intervals each of which corresponds to the least common multiple of generation periods of the voice frames of the mobile terminals;
(c) dividing the divided time interval corresponding to the least common multiple into QTX-INTs (QoS frame transmission intervals); and
(d) assigning the QoS slot to each of the QTX-INTs and transmitting the voice frame from each of the mobile terminals through the QoS slot.

2. The media access control method of claim 1, wherein the exchanging of frames for ensuring the QoS comprises:
(a1) transmitting a QRTS (QSLOT REQUEST TO SEND) frame for setting-up the QoS slot to the AP from each of the mobile terminals;
(a2) transmitting a QCRTS (QSLOT CHANGE REQUEST TO SEND) frame for changing the QoS slot from the AP to each of the mobile terminals which request to change the QoS slots for changing the QoS slot assigned to each of the mobile terminals; and
(a3) transmitting a QRRTS (QSLOT REMOVE REQUEST TO SEND) frame for requesting to remove the QoS slot assigned to each of the mobile terminals from each of the mobile terminals to the AP when each of the terminals completes in transmitting the voice frame.

3. The media access control method of claim 2, wherein (a1) comprises:
(a11) transmitting the QRTS frame from each of the mobile terminals to the AP;
(a12) transmitting a QGTS(QSLOT GRANT TO SEND) frame for granting the QoS slot in response to the request for the setting-up the QoS slot from the AP to each of the mobile terminals;
(a13) transmitting a Q-BEACON (QoS beacon) frame from the AP to each of the mobile terminals which have received the QGTS, extracting QoS slot information from the Q-BEACON, and transmitting the voice frame from each of the mobile terminals to the AP though the QoS slot; and
(a14) transmitting an ACK (acknowledgement) frame from the AP which has received the voice frame to each of the mobile terminals.

4. The media access control method of claim 2, wherein the QRTS comprises a transmission speed and generation frequency of the voice frame of each of the mobile terminals.

5. The media access control method of claim 3, wherein the QGTS comprises a QoS slot number of each of the mobile terminals.

6. The media access control method of claim 3, wherein the Q-BEACON comprises CFP (contention free period) information, a generation period of the voice frame, and a QoS slot number and QoS slot time, which is a duration time of the QoS slot, of each of the mobile terminals to which the QoS slots are assigned.

7. The media access control method of claim 2, wherein the QCRTS comprises a QoS slot number of each of the mobile terminals which request to change the QoS slots.

8. The media access control method of claim 2, wherein the QRRTS comprises a QoS slot number of the mobile terminal which requests to remove the QoS slot.

9. The media access control method of claim 1, wherein a duration time of the QTX-INT is a generation period of the greatest common divisor of generation periods of the voice frames of the mobile terminals.

10. The media access control method of claim 9, wherein the duration time of the QTX-INT comprises a CFP and a CP (contention period).

11. The media access control method of claim 10, wherein the number of each of the CFP and CP is the same as the number of the mobile terminals to which the QoS slots are assigned.

12. The media access control method of claim 11, wherein the CP is a period which is defined in the standard IEEE 802.11 DCF.

13. The media access control method of claim 1, wherein the QoS slot comprises a voice frame interval, an acknowledgement frame interval, a PIFS interval, and a SIFS interval.

14. The media access control method of claim 13, wherein (d) comprises:
(d1) each of the mobile terminals standing by for the PIFS time from a point in time when the QoS slot starts;
(d2) starting to transmit the voice frame to the AP when the PIFS interval elapses; and
(d3) transmitting the acknowledgement frame from the AP to each of the mobile terminals when the SIFS interval elapses after the transmission of the voice frame is completed.

15. The media access control method of claim 14, wherein the voice frame is retransmitted from each of the mobile terminals through arbitration among the AP and the other mobile terminals when each of the mobile terminals does not receive the acknowledgement frame from the AP.

16. The media access control method of claim 6, wherein a terminal of the mobile terminals to which the QoS slot has not been assigned extracts a QNAV (QoS SLOT Network Allocation Vector) frame assigned to the Q-BEACON to prohibit the transmission of the voice frame.

17. The media access control method of claim 16, wherein the terminal from which the transmission of the voice frame is prohibited can transmit the voice frame within a blank interval of the QoS slot.

18. The media access control method of claims 11, wherein transmitting the voice frame to a terminal among the mobile terminals which has not requested setting-up of a QoS slot comprises:
transmitting the voice frame from the AP to the terminal which has not requested setting-up of a QoS slot when the PIFS interval elapses after the CFP period is over; and
transmitting an acknowledge frame from the terminal which has not requested setting-up of a QoS slot to the AP when the SIFS elapses after the transmission is completed.

19. The media access control method of claims 13 wherein transmitting the voice frame to a terminal among the mobile terminals which has not requested setting-up of a QoS slot comprises:
transmitting the voice frame from the AP to the terminal which has not requested setting-up of a QoS slot when the PIFS interval elapses after the CFP period is over; and
transmitting an acknowledge frame from the terminal which has not requested setting-up of a QoS slot to the AP when the SIFS elapses after the transmission is completed.
